(19) United States
(12) Patent Application Publication
(10) Pub. No.: US 2005/0234871 A1
(43) Pub. Date: Oct. 20, 2005

(54) Indexing and search system and method with add-on request, indexing and search engines

(76) Inventors: Stephane Martin, Paris (FR); Guillaume Allys, Royere De Vassiviere (FR); Luc de Bois, Courbevoie (FR)

Correspondence Address: JAMES R. WILLIAMS;JAMISON, SELTZER, HARPER & WILLIAMS, 2625 WILMINGTON ROAD, NEW CASTLE, PA, 16105, US

(21) Appl. No.: 10/503,358

(22) PCT Filed: Jan. 30, 2003
(86) PCT No.: PCT/FR03/00287

§ 371 Date: Apr. 7, 2005

(30) Foreign Application Priority Data
Jan. 31, 2002 (FR) 02/01166

(51) Int. Cl. G06F 17/30

(52) U.S. Cl. 707/3

(57) ABSTRACT

The indexing and search system comprises means (10) for storing an indexing base (24), means (22) for indexing resources (18) to create and update the indexing base (24), means (40) for searching for resources and adapted to interrogate the indexing base (24) on the basis of a request, and request-extender means (38) for obtaining an extended request on the basis of an initial request (34) formulated by a user and including initial terms (R₁), by adding to said initial request (34) terms which are neighbors to the initial terms. The extender means (38) further comprise means (36) for limiting the extension of the initial request by adding thereto only terms that are neighbors to initial terms that are not general, i.e. Terms that do not have too great a number of neighbors. Means (20) for generalizing indexing may also be implemented in the invention.

The present invention relates to an indexing and search system.

More precisely, the invention relates to an indexing and search system of the type comprising means for storing an indexing base, means for indexing resources to create and update the indexing base, means for searching for resources and adapted to interrogate the indexing base on the basis of a request, and request-extender means for obtaining an extended request on the basis of an initial request formulated by a user and including initial terms, by adding to said initial request terms which are neighbors to the initial terms.

The invention also relates to a method of indexing and to a method of searching implemented by the system, and also to indexing and search engines.

In general, indexing and search systems include a semantic knowledge base containing a set of terms, each term possibly being associated with other terms in the same base which are semantically close thereto. Thus, when a user formulates a request in order to obtain in return pertinent documents that have been indexed by the indexing means, the search means enrich the initial request as formulated by the user with terms extracted from the knowledge base and which are semantically close to the initial terms of the request. This extension of the initial request by adding new terms that are neighbors to the initial terms can be reiterated. As a result, the search for documents is undertaken on the basis of an extended request having a larger number of terms than the initial request.

However, amongst the terms in the semantic knowledge base, some terms have a large number of neighboring terms, because they are very general. Thus, if a request includes any such general terms, when the request is extended there is a risk that it will end up having too great a number of terms and the search for documents runs the risk of being relatively ineffective and of consuming a large amount of time.

To mitigate that problem, certain indexing and search systems impose a predetermined maximum number of terms on the extended request. Those search and indexing systems stop extending a request once the maximum is reached, which means that the terms selected for the extended request are arbitrary. The search for documents then consumes less time, but to the detriment of pertinence.

The invention seeks to remedy the drawbacks of the above-mentioned conventional indexing and search systems, by providing a system that enables initial requests to be extended while still maintaining the effectiveness of the search for documents.

The invention thus provides an indexing and search system of the above-mentioned type, characterized in that the extender means include means for limiting the extension of the initial request by adding thereto only terms that are neighbors of initial terms that are not general, i.e. Terms that do not have too large a number of neighboring terms.

Thus, an indexing and search system of the invention enables the extension of the initial request to be limited in pertinent manner, i.e. By encouraging extension from precise terms rather than from general terms.

An indexing and search system of the invention may further include one or more of the following characteristics:
it includes means for extracting terms from each resource, and means for generalizing the indexing of said resource by adding to the extracted terms, general terms that are neighbors thereto;
the request-extender means include means for generalizing the initial request by adding to the initial terms of the request, general terms that are neighbors thereto;
the extender means comprise a semantic knowledge base containing a set of terms within which the initial terms of the request can be found, each term being optionally associated with a list of at least one neighboring term taken from said semantic knowledge base;
a term of the semantic knowledge base is a general term if it is associated with a list containing a number of neighboring terms that is greater than a predetermined threshold;
the system includes means for generating a limitation knowledge base and a generalization knowledge base from the semantic knowledge base, the limitation knowledge base being associated with the means for limiting extension and the generalization knowledge base being independent of the limitation knowledge base and being associated with the means for generalizing the initial request;
the limitation knowledge base contains all of the terms of the semantic knowledge base, and its terms that correspond to general terms of the semantic knowledge base are not associated with any list of neighboring terms; and
the generalization knowledge base contains all of the terms of the semantic knowledge base, and the lists of neighboring terms that it contains comprise only those terms that correspond to general terms of the semantic knowledge base.

The invention also provides a method of searching indexed resources, the method comprising the following steps:
issuing an initial request formulated by a user and including initial terms;
extending the initial request by adding to said initial request terms that are neighbors to the initial terms;
the method being characterized in that the extension step includes a sub step of extending the initial request by adding thereto only terms that are neighbors to initial terms that are not general, i.e. Initial terms that do not have too great a number of neighboring terms.

A method of searching indexed resources in accordance with the invention may further include the characteristic whereby the extension step includes a sub step of generalizing the initial request by adding to the initial terms of the request general terms that are neighbors thereto.

The invention also provides a method of indexing resources including a step of extracting terms from each resource, the method being characterized in that it further includes a step of generalizing the indexing of said resource by adding to said extracted terms general terms that are neighbors thereto.

The invention also provides an engine for indexing resources, the engine including means for extracting terms from each resource and being characterized in that it includes means for generalizing the indexing of said resource by adding to the extracted terms general terms that are neighbors thereto.

Finally, the invention also provides an engine for searching indexed resources, the engine including means for extracting initial terms from an initial request formulated by a user, means for searching the resources and adapted to interrogate an indexing base on the basis of a request, and request-extender means for obtaining an extended request from the initial request, the engine being characterized in that the extenderss means comprise means for limiting the extension of the initial request by adding thereto only terms that are neighbors to initial terms that are not general, i.e. Terms that do not have too great a number of neighboring terms.

A search engine of the invention may further include the characteristic whereby the extender means include means for generalizing the initial request by adding to the initial terms of the request, general terms that are neighbors thereto.

The invention will be better understood from the following description given purely by way of example and made with reference to the accompanying drawings, in which:

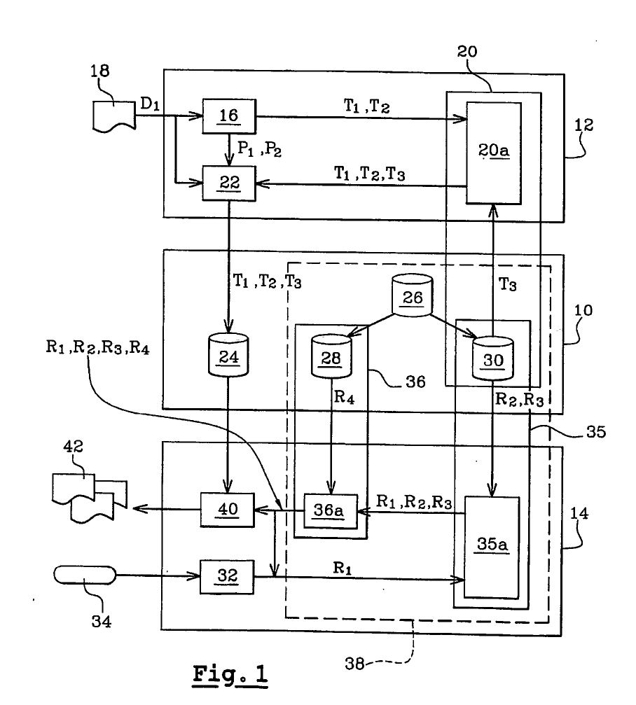

FIG. 1 is a diagram of the general structure of an indexing and searching system of the invention; and

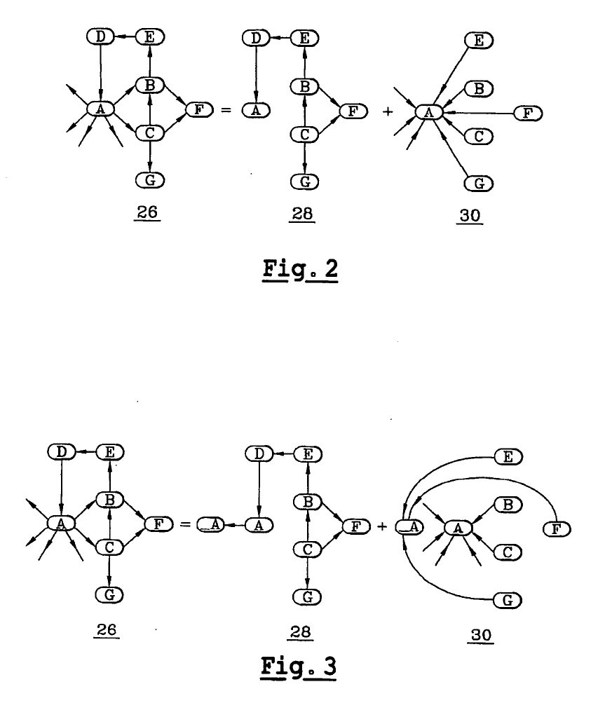

FIGS. 2 and 3 show the structure of the knowledge bases of the indexing and search system shown in FIG. 1, in two distinct embodiments.

The indexing and search system shown in FIG. 1 comprises storage means 10. It further comprises an indexing engine 12 and a search engine 14, both connected to the storage means 10.

The indexing engine 12 includes term-extractor means 16 receiving a document resource 18 as input from any document base accessible, e.g., via the Internet. By a known method of extraction, the means 16 supply terms T₁, T₂ that are extracted automatically from the document 18 and that are representative thereof. Each term extracted from the document 18 is forwarded to indexing-extender means 20a.

The indexing-extender means 20a supply, as output, the terms T₁ and T₂ associated with terms that are neighbors to T₁ and T₂ and that are taken from the storage means 10. For example, they supply a term T₃ that is semantically neighboring to the term T₁. They transmit the terms T₁, T₂, and T₃ to indexing means 22.

A reference D₁, for the document 18 is also transmitted to the indexing means 22. Finally, the extractor means 16 also transmit data to the indexing means 22 specifying the respective positions P₁ and P₂ of the extracted terms T₁ and T₂ in the document 18. The function of the indexing means 22 is to transfer all of this data to the storage means 10.

For this purpose, the storage means 10 include an indexing base 24. The indexing base 24 is made up of triplets each comprising a term, a reference to a document from which the term has been extracted, and the position of the term in that document. Thus, in the example given above, the indexing base contains a first triplet (T₁, D₁, P₁), a second triplet (T₂, D₁, P₂), and a third triplet (T₃, D₁, P₁). It should be observed that the term T₃ which is derived from T₁ is associated with the position P₁ of T₁ in D₁ .

The storage means 10 also include a semantic knowledge base 26 comprising a set of terms. The terms contained in this semantic knowledge base 26 represent all of the terms recognized by the indexing and search system, and they include in particular the terms T₁, T₂, and T₃.

Optionally, each term in the semantic knowledge base 26 is associated with a list of at least one semantically neighboring term taken from the same knowledge base 26.

The storage means 10 also include two distinct knowledge bases 28 and 30 constructed from the semantic knowledge base 26.

The first of these two distinct knowledge bases is a limitation knowledge base 28 which contains the same terms as the knowledge base 26. However, its terms that correspond to general terms of the knowledge base 26 are not associated with any list of neighboring terms, unlike the corresponding general terms of the semantic knowledge base 26.

The second knowledge base is a generalization knowledge base 30 which contains all of the terms of the knowledge base 26. The lists of neighboring terms that it contains comprise only terms corresponding to general terms of the knowledge base 26.

The knowledge base 26 is useful for generating the indexing and generalization knowledge bases 28 and 30, but it is not used by the indexing and search system. Its presence in the storage means 10 is therefore not necessary to enable the indexing and search system to operate. It is necessary solely for updating the knowledge bases 28 and 30 whenever the set of stored terms is modified.

The indexing extender means 20a are connected to read the generalization knowledge base 30. Thus, when the indexing extender means 20a receive a term input thereto, they output that term together with general terms taken from the list of terms that are neighbors to the term that has been received as input, which list is provided by the generalization knowledge base 30. The unit constituted by the indexing-extender means 20a and by the generalization knowledge base 30 thus forms indexing generalization means 20.

The search engine 14 includes term-extractor means 32 for extracting terms from an initial request 34 formulated by a user.

These extractor means 32 receive as input, a request 34 as formulated by the user, and they output a list of terms extracted from said request and contained in the knowledge base 26, such as the term R₁.

This list of terms is supplied to first request-extender means 35a. Like the indexing-extender means 20a, the first request-extender means 35a are connected to read the generalization knowledge base 30 and to co-operate therewith to form means 35 for generalizing the initial request 34. The first request-extender means 35a outputs the term R₁ together with terms R₂ and R₃ belonging to the list of neighboring terms associated with the term R₁ in the generalization knowledge base 30.

The terms R₁, R₂, and R₃ are supplied as inputs to second request-extender means 36a. These second request-extender means 36a are identical to the first request-extender means 35a, but they are connected to read the limitation knowledge base 28. As mentioned above, the general terms of the knowledge base 28 are not associated with any list of neighboring terms. Thus, the second request-extender means 36a in association with the limitation knowledge base 28 forms means 36 for limiting request extension. These means output an extended request constituted by the terms R₁, R₂, and R₃, and also a term R₄ supplied by the limitation knowledge base 28.

The generalization means 35 and the extension limitation means 36, possibly together with the knowledge base 28, constitute means 38 for extending the initial request. These means may be activated several times in an iterative process in order to extend the initial request progressively and output a final request which is transmitted to the search means 40.

The search means 40 are connected to the indexing base 24 of the storage means 10 and in response to the initial request formulated by the user 34 they supply a set 42 of document resources selected as a function of the terms R₁, R₂, R₃, and R₄ of the extended request.

A first implementation of the knowledge base 26 is shown in FIG. 2 in graphical form.

In this figure, the graphs comprise nodes such as nodes A, B, C, D, E, F, and G, each representing a term of the knowledge base. The nodes are optionally connected together by oriented arcs representing semantic links meaning “has as a directly-neighboring term”. Thus, term A has term B as a direct neighbor.

It can be considered that a term Y is a neighbor of a term X if there exists a path of no more than two oriented arcs from X to Y. Thus, term B has the term E as a direct neighbor. Term E is thus a neighbor of the term A.

It may also be considered that a term of the knowledge base 26 is a general term if it is has at least five direct neighbors.

In the example shown, only term A is a general term. It has six direct neighbors, including B and C. Term B has term F as its only direct neighbor. Term C has three direct neighbors B, F, and G. The terms B, C, E, F, and G are thus terms that are neighbors to term A.

Term C has four neighbors, B, E, F, and G. Term B has three neighbors D, E, and F. Term D has six neighbors including A and C, and term E has two neighbors, D and A. Terms F and G do not have any neighbors.

In the limitation knowledge base 28, the general term A has no direct neighbor since it is a general term in the knowledge base 26. However, all of the other terms have the same direct neighbors as in the knowledge base 26. That is to say only those oriented arcs that have A as their origin are omitted from the limitation knowledge base 28.

The generalization knowledge base 30 also has the same terms as the knowledge base 26. However the direct neighbors of a term in this base comprise all of the terms corresponding to general terms in the knowledge base 26 to which said term is a neighbor in said initial base. Thus, in the generalization knowledge base 30, only term A, which is the only general term in the knowledge base 26, is the direct neighbor of any other terms. In particular, it is the direct neighbor of terms B, C, E, F, and G which are its neighbors in the initial knowledge base, but it is not the direct neighbor of term D which does not belong to its neighborhood in the knowledge base 26.

Thus, while indexing documents, such as the document 18, the generalization knowledge base 30 supplies the means 20a with general terms that are neighbors to the terms extracted from the documents 18.

However, while extending a request, the limitation knowledge base 28 does not supply the second request-extender means 36a with terms that are neighbors to general terms in the request, since the corresponding oriented arcs have been omitted. This would be pointless, since documents containing terms in the semantic neighborhood of general terms in the request have already been indexed with said general terms by the indexing generalization means 20.

The second embodiment shown in FIG. 3 differs from the first embodiment by the way in which the limitation knowledge base 28 and the generalization knowledge base 30 are generated from the knowledge base 26.

This embodiment makes it possible to introduce the notion of the distance between a document and the terms used to index it, by creating artificial terms. Thus, in the limitation knowledge base 28, each term corresponding to a general term of the knowledge base 26 is represented by a plurality of terms, all of which except one are artificial terms. The real instance of a general term has in its direct neighborhood only the set of general artificial instances. All of the other terms of the limitation knowledge base 28 have the same semantic neighborhood as the corresponding terms in the knowledge base 26.

Finally, the distances between real instances of general terms and each corresponding artificial instance are defined.

In the generalization knowledge base 30, the only terms which have a direct neighbor are terms which, in the initial knowledge base, form part of the neighborhood of a general term.

The semantic neighborhood of a term in the generalization knowledge base 30 comprises all of the general terms of which it forms a part of the semantic neighborhood in the knowledge base 26, but each of these general terms is represented in the neighborhood by its real instance or by an artificial instance, as a function of the distance between said general term and the term under consideration.

Thus, as shown in FIG. 3, in the generalization knowledge base 30, the terms B and C have as neighbors the real instance of the general term A, whereas terms E, F, and G which are not neighbors of the general term A, are neighbors of the artificial instance of A.

By means of this embodiment, a request having the general term A only will enable a documentary resource having term B only to be found with a level of pertinence that is greater than a document resource that includes term E only.

The extension of the request including the general term A to a request including the general term A and its artificial instance makes it possible to find the second document, but with a level of pertinence that is lower than the first document, because of the distance between the general term A and its artificial instance in the limitation knowledge base 28.

It can clearly be seen that an indexing and search system with request extension in accordance with the invention makes it possible to optimize searching for document resources by controlling the extent to which a request is extended.

Nevertheless, it should be observed that the invention is not limited to the embodiment described above.

In a variant, the storage means 10 need not include a limitation knowledge base 28 and a generalization knowledge base 30 generated from the knowledge base 26.

Under such circumstances, the indexing generalization means 20 are fully integrated in the indexing engine 12 and are connected to read the knowledge base 26. They then include means for extracting only general terms from the knowledge base 26, including the terms which are neighbors to the terms supplied thereto as inputs.

Similarly, under such circumstances, the request generalization means 35 are fully integrated in the search engine 14 and are identical to the indexing generalization means 20.

Finally, likewise under such circumstances, the extension limiting means 36 are fully integrated in the search engine 14 and are connected to read the knowledge base 26. They are adapted to add to the terms supplied thereto, only terms which are neighbors to initial terms that are not general in the knowledge base 26.

1-14. (canceled)

15. An indexing and search system comprising:
a) means for storing an indexing base;
b) means for indexing resources to create and update the indexing base;
c) means for searching for resources and adapted to interrogate the indexing base with a request; and
d) request-extender means for obtaining an extended request with an initial request formulated by a user and including initial terms (R₁), by adding to the initial request terms which are neighbors to the initial terms and the extender means including means for limiting the extension of the initial request by adding thereto only terms that are neighbors of initial terms and that are not general.

16. The indexing and search system of claim 15, wherein the system includes means for extracting terms (T₁, T₂) from each resource, and means for generalizing the indexing of the resource by adding to the extracted terms, general terms (T₃) that are neighbors thereto.

17. The indexing and search system of claim 15, wherein the request-extender means include means for generalizing the initial request by adding to the initial terms of the request, general terms that are neighbors thereto.

18. The indexing and search system of claim 15, wherein the extender means comprises a semantic knowledge base containing a set of terms (T₁, T₂, T₃, R₁, R₂, R₃, R₄; A, B, C, D, E, F, G) within which the initial terms (R₁) of the request can be found, each term being optionally associated with a list of at least one neighboring term taken from the semantic knowledge base.

19. The indexing and search system of claim 18, wherein a term (T₁, T₂, T₃, R₁, R₂, R₃, R₄; A, B, C, D, E, F, G) of the semantic knowledge base is a general term associated with a list containing a number of neighboring terms that is greater than a predetermined threshold.

20. The indexing and search system of claim 18, wherein the system ncludes means for generating a limitation knowledge base and a generalization knowledge base from the semantic knowledge base, the limitation knowledge base being associated with the means for limiting extension and the generalization knowledge base being independent of the limitation knowledge base and being associated with the means for generalizing the initial request.

21. The indexing and search means of claim 20, wherein the limitation knowledge base contains all terms of the semantic knowledge base and the terms correspond to general terms of the semantic knowledge base that are not associated with any list of neighboring terms.

22. The indexing and search system of claim 20, wherein the generalization knowledge base contains all terms of the semantic knowledge base, and the lists of neighboring terms that the generalization knowledge base contains comprise only those terms that correspond to general terms of the semantic knowledge base.

23. A method of searching indexed resources, the method comprising the following steps:
a) issuing an initial request formulated by a user and including initial terms (R₁);
b) extending the initial request by adding to the initial request terms that are neighbors to the initial terms (R₁) and includes a sub step of extending the initial request by adding thereto only terms (R₄) that are neighbors to initial terms that are not general.

24. The method of searching indexed resources of claim 23, wherein the extension step includes a sub step of generalizing the initial request by adding to the initial terms of the request general terms (R₂, R₃) that are neighbors thereto.

25. A method of indexing resources including a step of extracting terms (T₁, T₂) from each resource, and generalizing the indexing of the resource by adding to the extracted terms general terms (T₃) that are neighbors thereto.

26. An engine for indexing resources, the engine including means for extracting terms from each resource and means for generalizing the indexing of the resource by adding to the extracted terms general terms that are neighbors thereto.

27. An engine for searching indexed resources, the engine including means for extracting initial terms from an initial request formulated by a user, means for searching the resources and adapted to interrogate an indexing base on the basis of a request, and request-extender means for obtaining an extended request from the initial request, the extender means comprising means for limiting the extension of the initial request by adding thereto only terms that are neighbors to initial terms that are not general.

28. The engine for searching indexed resources of claim 27, wherein the extender means include means for generalizing the initial request by adding to the initial terms of the request, general terms that are neighbors thereto.
